(19) United States
(12) Patent Application Publication
(10) Pub. No.: US 2025/0138886 A1
(43) Pub. Date: May 1, 2025

(54) SYSTEMS AND METHODS FOR DISTRIBUTING BASEBOARD MANAGEMENT CONTROLLER (BMC) SERVICES OVER A CLOUD ARCHITECTURE

(71) Applicant: Dell Products, L.P., Round Rock, TX (US)

(72) Inventors: Venkatesh Ramamoorthy, Round Rock, TX (US); Diwahar Natarajan, Austin, TX (US); Arun Muthaiyan, Round Rock, TX (US); Arulnambi Raju, Round Rock, TX (US)

(73) Assignee: Dell Products, L.P., Round Rock, TX (US)

(21) Appl. No.: 18/493,863

(22) Filed: Oct. 25, 2023

(51) Int. Cl. G06F 9/50; H04L 9/40

(52) U.S. Cl. CPC G06F 9/5027; H04L 63/029

(57) ABSTRACT

Embodiments of the present disclosure provide systems and methods to distribute Baseboard Management Controller (BMC) services over a cloud architecture. According to one embodiment, an Information Handling System (IHS) includes a Baseboard Management Controller (BMC) that is configured to execute multiple services for managing the operation of the IHS, and computer-executable code that is stored in at least one memory and executed by at least one processor for executing a first subset of the services on the BMC, and executing a second subset of the services on a cloud computing environment in communication with the BMC.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Modern day IHS administrative management is often provided via baseboard management controllers (BMCs). The baseboard management controller (BMC) generally includes a specialized microcontroller embedded in the IHS, and may provide an interface between system-management software and platform hardware. Different types of sensors built into the IHS report to the BMC on parameters such as temperature, cooling fan speeds, power status, operating system (O/S) status, and the like. The BMC monitors the sensors and can send alerts to a system administrator via the network if any of the parameters do not stay within pre-set limits, indicating a potential failure of the system. The administrator can also remotely communicate with the BMC to take certain corrective actions, such as resetting or power cycling the system to get a hung O/S running again. These abilities can often save on the total cost of ownership of an IHS, particularly when implemented in large clusters, such as server farms.

Many computer processing architectures have recently migrated toward cloud computing. Cloud computing generally involves the delivery of computing services (e.g., Software As A Service (SAAS)) over the Internet. With cloud computing, a virtualized pool of resources, from raw compute power at the infrastructure level to application functionality, is often made available to a client, on demand, by a provider. One particular advantage of cloud computing is the ability to apply abstracted versions of compute, storage, and network resources to workloads, as needed, and tap into an abundance of prebuilt services. Cloud computing may enable users to tap into additional capabilities without requiring the investment of the infrastructure, such as new hardware or software. Rather, users often pay the provider of the cloud service a subscription fee or in some cases lease the infrastructure that they use.

### SUMMARY

Embodiments of the present disclosure provide systems and methods to distribute Baseboard Management Controller (BMC) services over a cloud architecture. According to one embodiment, an Information Handling System (IHS) includes a Baseboard Management Controller (BMC) that is configured to execute multiple services for managing the operation of the IHS, and computer-executable code that is stored in at least one memory and executed by at least one processor for executing a first subset of the services on the BMC, and executing a second subset of the services on a cloud computing environment in communication with the BMC.

According to another embodiment, a cloud-based service distribution method includes the steps off providing a Baseboard Management Controller (BMC) that is configured to execute a plurality of services for managing the operation of an Information Handling System (IHS), executing a first subset of the services on the BMC, and executing a second subset of the services on a cloud computing environment in communication with the BMC.

According to yet another embodiment, a memory storage device is configured with program instructions that, upon execution by one or more processors of a client Information Handling System (IHS), cause the client IHS to execute a first subset of the services on a Baseboard Management Controller (BMC) that is configured to execute a plurality of services for managing the operation of the HIS, and execute a second subset of the services on a cloud computing environment in communication with the BMC.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIGS. 1A and 1B illustrate certain components of a chassis comprising one or more compute sleds and one or more storage sleds that may be configured to implement the systems and methods described according to one embodiment of the present disclosure.

FIG. 2 illustrates an example of an IHS configured to implement systems and methods described herein according to one embodiment of the present disclosure.

FIG. 3 illustrates several components of a cloud-based service distribution system that may be used to distribute Baseboard Management Controller (BMC) services over a cloud architecture according to one embodiment of the present disclosure.

FIG. 4 illustrates several elements of an IHS configured with a BMC showing several example services that may be executed by either the cloud-based BMC firmware configured in the cloud computing environment, or the local BMC firmware configured in each BMC according to one embodiment of the present disclosure.

FIG. 5 illustrates an example cloud-based service distribution method showing how multiple services may be distributed between a BMC and a cloud computing environment according to one embodiment of the present disclosure.

FIG. 6 illustrates an example window that may be generated by the cloud-based service distribution system to receive user input for determining whether each service should be executed on either the cloud computing environment or locally on the BMC.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer's operating system or BIOS) hardware management tasks. The BMC firmware can support industry-standard specifications, such as the Intelligent Platform Management Interface (IPMI) and Systems Management Architecture of Server Hardware (SMASH) for computer system administration. The BMC may include a processor, memory, and an out-of-band network interface separate from and physically isolated from an in-band network interface of the IHS, and/or other embedded resources. In certain embodiments, the BMC may include or may be part of a BMC (e.g., a DELL Remote Access Controller (DRAC) or an Integrated DRAC (iDRAC)).

The BMC firmware is normally proprietary and is often developed by the vendor and shipped along with the BMC to the end user. Nevertheless, industry trends have migrated toward custom BMC firmware stacks (e.g., operating systems) that allow the end user greater control over how the BMC operates. OpenBMC is one example standard under which custom BMC firmware stacks may be generated. In general, openBMC is a collaborative open-source Linux distribution for BMCs meant to work across heterogeneous systems that include enterprise, high-performance computing (HPC), telecommunications, and cloud-scale data centers.

Advances in BMC design has led to the development implementation of an Inter-Process Communication (IPC) and remote procedure call (RPC) mechanism, such as Desktop Bus (D-Bus), which typically operate outside the operating-system space. D-Bus is usually provided as a “daemon” process that functions in the background to effectively facilitate exchange of IPC messages between processes that provide various services. Implementation of D-Bus in BMCs are advantageous in that it provides for abstraction of invoking interfaces of a service and responding to interface invocations. Thus, the service may be shielded from, among other things, serialization and deserialization of data shared with other services, thus yielding portable services that may be easily migrated from one platform to another. Because D-Bus is a standard feature provided by the openBMC platform, it may be beneficial to re-use established services on other platforms, such as vendor-based platforms, such as Open Server Manager (OMS) provided by DELL TECHNOLOGIES and vice-versa.

Nevertheless, while implementation of D-Bus in BMCs may provide enhanced manageability, transparency, and customization, its implementation has not been without drawbacks. For example, existing D-Bus services and utilities are designed for convenience and not for performance, especially with regard to object interfaces and how their property information is handled. Using D-Bus, applications may experience a noticeable decrease in performance, particularly when attempting to fetch more than a handful of objects and their interface's property information. These performance issues scale with the number of objects and/or properties that need to be retrieved. Using a BMC Graphical User Interface (GUI) (e.g., iDRAC GUI) as an example, when the GUI is launched, dozens of backend Redfish requests that fetch large blocks of BMC configuration attribute data typically occur in a relatively short period of time, thus causing D-Bus objects to experience significant performance degradation relative to legacy BMC firmware that does not use D-Bus for IPC.

Additionally, the BMC feature set has been steadily increasing, thus yielding larger firmware image sizes. With more platforms and peripherals continually being added, it is expected that the feature set is going to continue to increase. As such, new feature support may become limited, and in some cases necessitate the removal of other features or require increased hardware cost. Many new feature deliveries are often accompanied with a BMC update procedure followed by a reboot procedure, which costs a non-trivial amount of downtime to its respective server. As will be described in detail herein below, embodiments of the present disclosure provide systems and methods for distributing Baseboard Management Controller (BMC) services over a cloud architecture in which certain services provided by the BMC may be offloaded to a cloud-based architecture. Also, services provided by the cloud-based architecture, when updated from time to time, may alleviated of the need to perform an update/reboot procedure each time a new feature is added to the BMC because the administrator of the cloud-based architecture, rather than the user, would be mainly responsible for updating the BMC's firmware. As will be described in detail herein below, embodiments of the present disclosure provide systems and methods for distributing Baseboard Management Controller (BMC) services over a cloud architecture so that, among other things, a processing load on the BMC may be reduced.

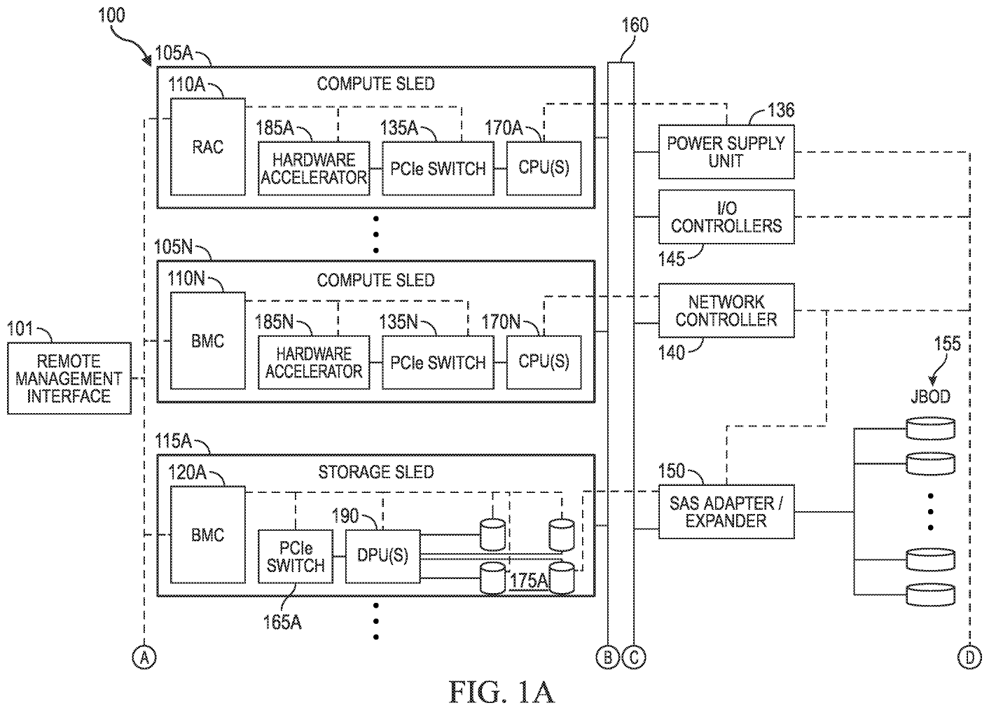

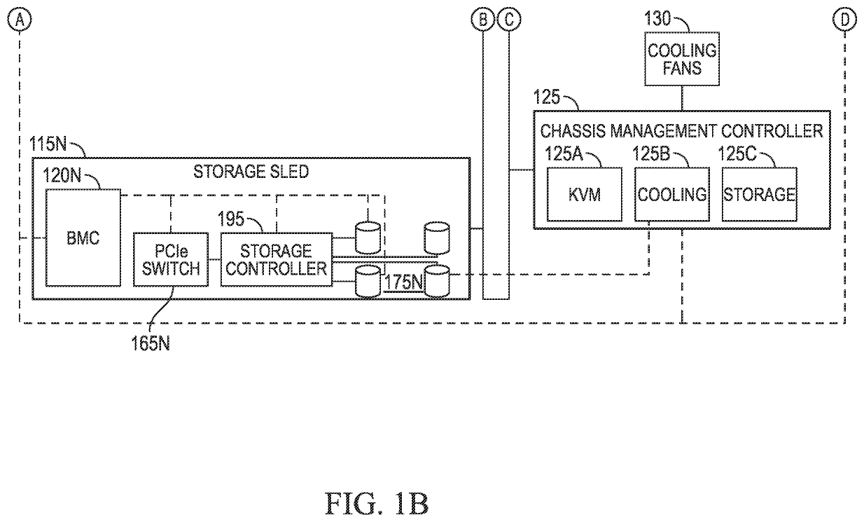

FIG. 1 is a block diagram illustrating certain components of a chassis 100 comprising one or more compute sleds 105a-n and one or more storage sleds 115a-n that may be configured to implement the systems and methods described according to one embodiment of the present disclosure. Embodiments of chassis 100 may include a wide variety of hardware configurations in which one or more sleds 105a-n, 115a-n are installed in chassis 100. Such variations in hardware configuration may result from chassis 100 being factory assembled to include components specified by a customer that has contracted for manufacture and delivery of chassis 100. Upon delivery and deployment of a chassis 100, the chassis 100 may be modified by replacing and/or adding various hardware components, in addition to replacement of the removable sleds 105a-n, 115a-n that are installed in the chassis. In addition, once the chassis 100 has been deployed, firmware used by individual hardware components of the sleds 105a-n, 115a-n, or by other hardware components of chassis 100, may be modified in order to update the operations that are supported by these hardware components.

Chassis 100 may include one or more bays that each receive an individual sled (that may be additionally or alternatively referred to as a tray, blade, and/or node), such as compute sleds 105a-n and storage sleds 115a-n. Chassis 100 may support a variety of different numbers (e.g., 4, 8, 16, 32), sizes (e.g., single-width, double-width) and physical configurations of bays. Embodiments may include additional types of sleds that provide various storage, power and/or processing capabilities. For instance, sleds installable in chassis 100 may be dedicated to providing power management or networking functions. Sleds may be individually installed and removed from the chassis 100, thus allowing the computing and storage capabilities of a chassis to be reconfigured by swapping the sleds with diverse types of sleds, in some cases at runtime without disrupting the ongoing operations of the other sleds installed in the chassis 100.

Multiple chassis 100 may be housed within a rack. Data centers may utilize large numbers of racks, with various different types of chassis installed in various configurations of racks. The modular architecture provided by the sleds, chassis and racks allow for certain resources, such as cooling, power, and network bandwidth, to be shared by the compute sleds 105a-n and storage sleds 115a-n, thus providing efficiency improvements and supporting greater computational loads. For instance, certain computational tasks, such as computations used in machine learning and other artificial intelligence systems, may utilize computational and/or storage resources that are shared within an IHS, within an individual chassis 100 and/or within a set of IHSs that may be spread across multiple chassis of a data center.

Implementing computing systems that span multiple processing components of chassis 100 is aided by high-speed data links between these processing components, such as PCIe connections that form one or more distinct PCIe switch fabrics that are implemented by PCIe switches 135a-n, 165a-n installed in the sleds 105a-n, 115a-n of the chassis. These high-speed data links may be used to support algorithm implementations that span multiple processing, networking, and storage components of an IHS and/or chassis 100. For instance, computational tasks may be delegated to a specific processing component of an IHS, such as to a hardware accelerator 185a-n that may include one or more programmable processors that operate separate from the main CPUs 170a-n of computing sleds 105a-n. In various embodiments, such hardware accelerators 185a-n may include DPUs (Data Processing Units), GPUs (Graphics Processing Units), SmartNICs (Smart Network Interface Card) and/or FPGAs (Field Programmable Gate Arrays). These hardware accelerators 185a-n operate according to firmware instructions that may be occasionally updated, such as to adapt the capabilities of the respective hardware accelerators 185a-n to specific computing tasks.

Chassis 100 may be installed within a rack structure that provides at least a portion of the cooling utilized by the sleds 105a-n, 115a-n installed in chassis 100. In supporting airflow cooling, a rack may include one or more banks of cooling fans that may be operated to ventilate heated air from within the chassis 100 that is housed within the rack. The chassis 100 may alternatively or additionally include one or more cooling fans 130 that may be similarly operated to ventilate heated air away from sleds 105a-n, 115a-n installed within the chassis. In this manner, a rack and a chassis 100 installed within the rack may utilize various configurations and combinations of cooling fans 130 to cool the sleds 105a-n, 115a-n and other components housed within chassis 100.

The sleds 105a-n, 115a-n may be individually coupled to chassis 100 via connectors that correspond to the bays provided by the chassis 100 and that physically and electrically couple an individual sled to a backplane 160. Chassis backplane 160 may be a printed circuit board that includes electrical traces and connectors that are configured to route signals between the various components of chassis 100 that are connected to the backplane 160 and between different components mounted on the printed circuit board of the backplane 160. In the illustrated embodiment, the connectors for use in coupling sleds 105a-n, 115a-n to backplane 160 include PCIe couplings that support high-speed data links with the sleds 105a-n, 115a-n. In various embodiments, backplane 160 may support diverse types of connections, such as cables, wires, midplanes, connectors, expansion slots, and multiplexers. In certain embodiments, backplane 160 may be a motherboard that includes various electronic components installed thereon. Such components installed on a motherboard backplane 160 may include components that implement all or part of the functions described with regard to the SAS (Serial Attached SCSI) expander 150, I/O controllers 145, network controller 140, chassis management controller 125 and power supply unit 136.

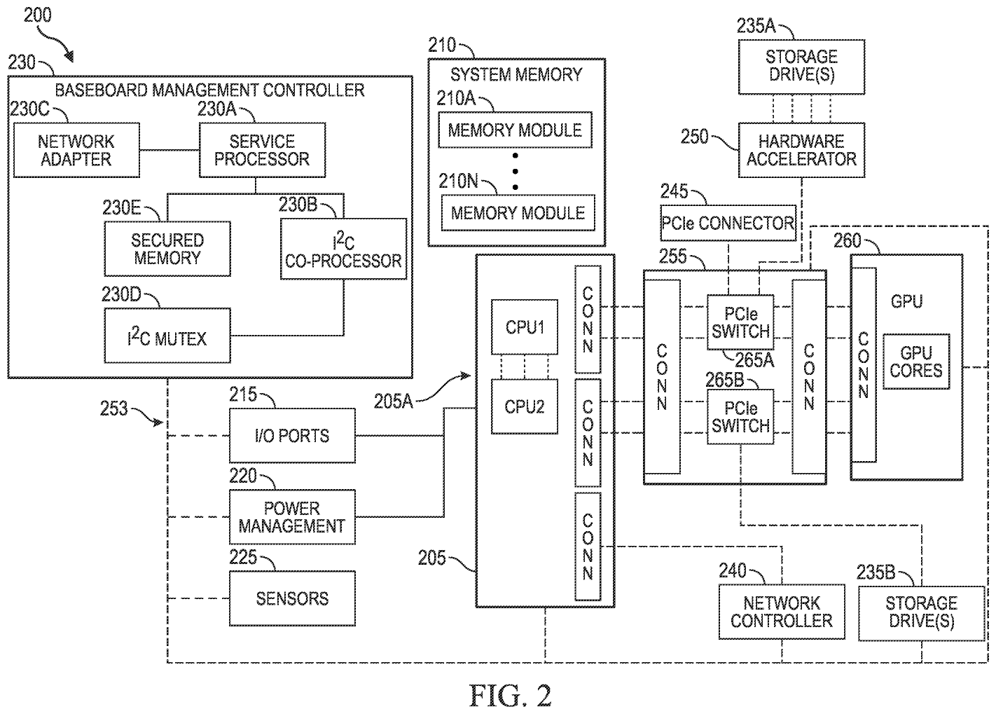

In certain embodiments, each individual sled 105a-n, 115a-n-n may be an IHS such as described with regard to IHS 200 of FIG. 2. Sleds 105a-n, 115a-n may individually or collectively provide computational processing resources that may be used to support a variety of e-commerce, multimedia, business, and scientific computing applications, such as artificial intelligence systems provided via cloud computing implementations. Sleds 105a-n, 115a-n are typically configured with hardware and software that provide leading-edge computational capabilities. Accordingly, services that are provided using such computing capabilities are typically provided as high-availability systems that operate with minimum downtime.

In high-availability computing systems, such as may be implemented using embodiments of chassis 100, any downtime that can be avoided is preferred. As described above, firmware updates are expected in the administration and operation of data centers, but it is preferable to avoid any downtime in making such firmware updates. For instance, in updating the firmware of the individual hardware components of the chassis 100, it is preferable that such updates can be made without having to reboot the chassis. As described in additional detail below, it is also preferable that updates to the firmware of individual hardware components of sleds 105a-n, 115a-n be likewise made without having to reboot the respective sled of the hardware component that is being updated.

As illustrated, each sled 105a-n, 115a-n includes a respective Baseboard Management Controller (BMC) 110a-n, 120a-n also known as a remote access controller (RAC). As described in additional detail with regard to FIG. 2, BMC 110a-n, 120a-n provides capabilities for remote monitoring and management of a respective sled 105a-n, 115a-n and/or of chassis 100. In support of these monitoring and management functions, BMCs 110a-n may utilize both in-band and sideband (i.e., out-of-band) communications with various managed components of a respective sled 105a-n and chassis 100. Remote access controllers 110a-n, 120a-n may collect diverse types of sensor data, such as collecting temperature sensor readings that are used in support of airflow cooling of the chassis 100 and the sleds 105a-n, 115a-n. In addition, each BMC 110a-n, 120a-n may implement various monitoring and administrative functions related to a respective sled 105a-n, 115a-n, where these functions may be implemented using sideband bus connections with various internal components of the chassis 100 and of the respective sleds 105a-n, 115a-n. As described in additional detail below, in various embodiments, these capabilities of the BMCs 110a-n, 120a-n may be utilized in updating the firmware of hardware components of chassis 100 and/or of hardware components of the sleds 105a-n, 115a-n, without having to reboot the chassis or any of the sleds 105a-n, 115a-n.

The BMCs 110a-n, 120a-n that are present in chassis 100 may support secure connections with a remote management interface 101. In some embodiments, remote management interface 101 provides a remote administrator with various capabilities for remotely administering the operation of an IHS, including initiating updates to the firmware used by hardware components installed in the chassis 100. For example, remote management interface 101 may provide capabilities by which an administrator can initiate updates to all of the storage drives 175a-n installed in a chassis 100, or to all of the storage drives 175a-n of a particular model or manufacturer. In some instances, remote management interface 101 may include an inventory of the hardware, software, and firmware of chassis 100 that is being remotely managed through the operation of the BMCs 110a-n, 120a-n. The remote management interface 101 may also include various monitoring interfaces for evaluating telemetry data collected by the BMCs 110a-n, 120a-n. In some embodiments, remote management interface 101 may communicate with BMCs 110a-n, 120a-n via a protocol such the Redfish remote management interface.

In the illustrated embodiment, chassis 100 includes one or more compute sleds 105a-n that are coupled to the backplane 160 and installed within one or more bays or slots of chassis 100. Each of the individual compute sleds 105a-n may be an IHS, such as described with regard to FIG. 2. Each of the individual compute sleds 105a-n may include various different numbers and types of processors that may be adapted to performing specific computing tasks. In the illustrated embodiment, each of the compute sleds 105a-n includes a PCIe switch 135a-n that provides access to a hardware accelerator 185a-n, such as the described DPUs, GPUs, Smart NICs and FPGAs, which may be programmed and adapted for specific computing tasks, such as to support machine learning or other artificial intelligence systems. As described in additional detail below, compute sleds 105a-n may include a variety of hardware components, such as hardware accelerator 185a-n and PCIe switches 135a-n, that operate using firmware that may be occasionally updated.

As illustrated, chassis 100 includes one or more storage sleds 115a-n that are coupled to the backplane 160 and installed within one or more bays of chassis 100 in a similar manner to compute sleds 105a-n. Each of the individual storage sleds 115a-n may include various different numbers and types of storage devices. As described in additional detail with regard to FIG. 2, a storage sled 115a-n may be an IHS 200 that includes multiple solid-state drives (SSDs) 175a-n, where the individual storage drives 175a-n may be accessed through a PCIe switch 165a-n of the respective storage sled 115a-n.

As illustrated, a storage sled 115a may include one or more DPUs (Data Processing Units) 190 that provide access to and manage the operations of the storage drives 175a of the storage sled 115a. Use of a DPU 190 in this manner provides low-latency and high-bandwidth access to numerous SSDs 175a. These SSDs 175a may be utilized in parallel through NVMe transmissions that are supported by the PCIe switch 165a that connects the SSDs 175a to the DPU 190. In some instances, PCIe switch 165a may be an integrated component of a DPU 190. The immense data storage and retrieval capabilities provided by such storage sled 115a implementations may be harnessed by offloading storage operations directed as storage drives 175a to a DPU 190a, and thus without relying on the main CPU of the storage sled, or of any other component of chassis 100. As indicated in FIG. 1, chassis 100 may also include one or more storage sleds 115n that provide access to storage drives 175n via a storage controller 195. In some embodiments, storage controller 195 may provide support for RAID (Redundant Array of Independent Disks) configurations of logical and physical storage drives, such as storage drives provided by storage sled 115n. In some embodiments, storage controller 195 may be a HBA (Host Bus Adapter) that provides more limited capabilities in accessing storage drives 175n.

In addition to the data storage capabilities provided by storage sleds 115a-n, chassis 100 may provide access to other storage resources that may be installed components of chassis 100 and/or may be installed elsewhere within a rack that houses the chassis 100. In certain scenarios, such storage drives 155 may be accessed via a SAS expander 150 that is coupled to the backplane 160 of the chassis 100. The SAS expander 150 may support connections to a number of JBOD (Just a Bunch of Disks) storage drives 155 that, in some instances, may be configured and managed individually and without implementing data redundancy across the various drives 155. The additional storage drives 155 may also be at various other locations within a datacenter in which chassis 100 is installed.

In light of the various manners in which storage drives 175a-n, 155 may be coupled to chassis 100, a wide variety of different storage topologies may be supported. Through these supported topologies, storage drives 175a-n, 155 may be logically organized into clusters or other groupings that may be collectively tasked and managed. In some instances, a chassis 100 may include numerous storage drives 175a-n, 155 that are identical, or nearly identical, such as arrays of SSDs of the same manufacturer and model. Accordingly, any firmware updates to storage drives 175a-n, 155 require the updates to be applied within each of these topologies being supported by the chassis 100. Despite the substantial number of different storage drive topologies that may be supported by an individual chassis 100, the firmware used by each of these storage devices 175a-n, 155 may be occasionally updated. In some instances, firmware updates may be limited to a single storage drive, but in other instances, firmware updates may be initiated for a large number of storage drives, such as for all SSDs installed in chassis 100.

As illustrated, the chassis 100 of FIG. 1 includes a network controller 140 that provides network access to the sleds 105a-n, 115a-n installed within the chassis. Network controller 140 may include various switches, adapters, controllers, and couplings used to connect chassis 100 to a network, either directly or via additional networking components and connections provided via a rack in which chassis 100 is installed. Network controller 140 operates according to firmware instructions that may be occasionally updated.

Chassis 100 may similarly include a power supply unit 136 that provides the components of the chassis with various levels of DC power from an AC power source or from power delivered via a power system provided by a rack within which chassis 100 may be installed. In certain embodiments, power supply unit 136 may be implemented within a sled that may provide chassis 100 with redundant, hot-swappable power supply units. Power supply unit 136 may operate according to firmware instructions that may be occasionally updated.

Chassis 100 may also include various I/O controllers 145 that may support various I/O ports, such as USB ports that may be used to support keyboard and mouse inputs and/or video display capabilities. Each of the I/O controllers 145 may operate according to firmware instructions that may be occasionally updated. Such I/O controllers 145 may be utilized by the chassis management controller 125 to support various KVM (Keyboard, Video and Mouse) 125a capabilities that provide administrators with the ability to interface with the chassis 100. The chassis management controller 125 may also include a storage module 125c that provides capabilities for managing and configuring certain aspects of the storage devices of chassis 100, such as the storage devices provided within storage sleds 115a-n and within the JBOD 155.

In addition to providing support for KVM 125a capabilities for administering chassis 100, chassis management controller 125 may support various additional functions for sharing the infrastructure resources of chassis 100. In some scenarios, chassis management controller 125 may implement tools for managing the power supply unit 136, network controller 140 and airflow cooling fans 130 that are available via the chassis 100. As described, the airflow cooling fans 130 utilized by chassis 100 may include an airflow cooling system that is provided by a rack in which the chassis 100 may be installed and managed by a cooling module 125b of the chassis management controller 125.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 illustrates an example of an IHS 200 configured to implement systems and methods described herein according to one embodiment of the present disclosure. It should be appreciated that although the embodiments described herein may describe an IHS that is a compute sled or similar computing component that may be deployed within the bays of a chassis, a variety of other types of IHSs, such as laptops and portable devices, may also operate according to embodiments described herein. In the illustrative embodiment of FIG. 2, IHS 200 may be a computing component, such as sled 105a-n, 115a-n, or other type of server, such as an 1RU server installed within a 2RU chassis, which is configured to share infrastructure resources provided within a chassis 100.

IHS 200 may utilize one or more system processors 205, that may be referred to as CPUs (central processing units). In some embodiments, CPUs 205 may each include a plurality of processing cores that may be separately delegated with computing tasks. Each of the CPUs 205 may be individually designated as a main processor and as a co-processor, where such designations may be based on delegation of specific types of computational tasks to a CPU 205. In some embodiments, CPUs 205 may each include an integrated memory controller that may be implemented directly within the circuitry of each CPU 205. In some embodiments, a memory controller may be a separate integrated circuit that is located on the same die as the CPU 205. Each memory controller may be configured to manage the transfer of data to and from a system memory 210 of the HIS 200, in some cases using a high-speed memory bus. The system memory 210 is coupled to CPUs 205 via one or more memory buses 205a that provide the CPUs 205 with high-speed memory used in the execution of computer program instructions by the CPUs 205. Accordingly, system memory 210 may include memory components, such as static RAM (SRAM), dynamic RAM (DRAM), NAND Flash memory, suitable for supporting high-speed memory operations by the CPUs 205. In certain embodiments, system memory 210 may combine persistent non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to diverse types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each CPU 205. All or portions of the chipset may be implemented directly within the integrated circuitry of an individual CPU 205. The chipset may provide the CPU 205 with access to a variety of resources accessible via one or more in-band buses. IHS 200 may also include one or more I/O ports 215 that may be used to couple the IHS 200 directly to other IHSs, storage resources, diagnostic tools, and/or other peripheral components. A variety of additional components may be coupled to CPUs 205 via a variety of in-line buses. For instance, CPUs 205 may also be coupled to a power management unit 220 that may interface with a power system of the chassis 100 in which IHS 200 may be installed. In addition, CPUs 205 may collect information from one or more sensors 225 via a management bus.

In certain embodiments, IHS 200 may operate using a BIOS (Basic Input/Output System) that may be stored in a non-volatile memory accessible by the CPUs 205. The BIOS may provide an abstraction layer by which the operating system of the IHS 200 interfaces with hardware components of the IHS 200. Upon powering or restarting IHS 200, CPUs 205 may utilize BIOS instructions to initialize and test hardware components coupled to the IHS 200, including both components permanently installed as components of the motherboard of IHS 200 and removable components installed within various expansion slots supported by the IHS 200. The BIOS instructions may also load an operating system for execution by CPUs 205. In certain embodiments, IHS 200 may utilize Unified Extensible Firmware Interface (UEFI) in addition to or instead of a BIOS. In certain embodiments, the functions provided by a BIOS may be implemented, in full or in part, by the BMC 230.

In some embodiments, IHS 200 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of HIS 200, such as the BIOS and boot loader of IHS 200. These calculated hash values may then be compared against reference hash values that were previously stored in a secure non-volatile memory of the HIS 200, such as during factory provisioning of IHS 200. In this manner, a TPM may establish a root of trust that includes core components of IHS 200 that are validated as operating using instructions that originate from a trusted source.

As illustrated, CPUs 205 may be coupled to a network controller 240, such as provided by a Network Interface Controller (NIC) card that provides IHS 200 with communications via one or more external networks, such as the Internet, a LAN, or a WAN. In some embodiments, network controller 240 may be a replaceable expansion card or adapter that is coupled to a connector (e.g., PCIe connector of a motherboard, backplane, midplane, etc.) of IHS 200. In some embodiments, network controller 240 may support high-bandwidth network operations by the IHS 200 through a PCIe interface that is supported by the chipset of CPUs 205. Network controller 240 may operate according to firmware instructions that may be occasionally updated.

As indicated in FIG. 2, in some embodiments, CPUs 205 may be coupled to a PCIe card 255 that includes two PCIe switches 265a-b that operate as I/O controllers for PCIe communications, such as TLPs (Transaction Layer Packets), that are transmitted between the CPUs 205 and PCIe devices and systems coupled to IHS 200. Whereas the illustrated embodiment of FIG. 2 includes two CPUs 205 and two PCIe switches 265a-b, different embodiments may operate using different numbers of CPUs and PCIe switches. In addition to serving as I/O controllers that route PCIe traffic, PCIe switches 265a-b include switching logic that can be used to expand the number of PCIe connections that are supported by CPUs 205. PCIe switches 265a-b may multiply the number of PCIe lanes available to CPUs 205, thus allowing more PCIe devices to be connected to CPUs 205, and for the available PCIe bandwidth to be allocated with greater granularity. Each of the PCIe switches 265a-b may operate according to firmware instructions that may be occasionally updated.

Using the available PCIe lanes, the PCIe switches 265a-b may be used to implement a PCIe switch fabric. Also through this switch fabric, PCIe NVMe (Non-Volatile Memory Express) transmission may be supported and utilized in high-speed communications with SSDs, such as storage drives 235a-b, of the IHS 200. Also through this switch fabric, PCIe VDM (Vendor Defined Messaging) may be supported and utilized in managing PCIe-compliant hardware components of the IHS 200, such as in updating the firmware utilized by the hardware components.

As indicated in FIG. 2, IHS 200 may support storage drives 235a-b in various topologies, in the same manner as described with regard to the chassis 100 of FIG. 1. In the illustrated embodiment, storage drives 235a are accessed via a hardware accelerator 250, while storage drives 235b are accessed directly via PCIe switch 265b. In some embodiments, the storage drives 235a-b of IHS 200 may include a combination of both SSD and magnetic disk storage drives. In other embodiments, all of the storage drives 235a-b of IHS 200 may be identical, or nearly identical. In all embodiments, storage drives 235a-b operate according to firmware instructions that may be occasionally updated.

As illustrated, PCIe switch 265a is coupled via a PCIe link to a hardware accelerator 250, such as a DPU, SmartNIC, GPU and/or FPGA, that may be a connected to the IHS 200 via a removable card or baseboard that couples to a PCIe connector of the IHS 200. In some embodiments, hardware accelerator 250 includes a programmable processor that can be configured for offloading functions from CPUs 205. In some embodiments, hardware accelerator 250 may include a plurality of programmable processing cores and/or hardware accelerators, which may be used to implement functions used to support devices coupled to the IHS 200. In some embodiments, the processing cores of hardware accelerator 250 include ARM (advanced RISC (reduced instruction set computing) machine) processing cores. In other embodiments, the cores of the DPUs may include MIPS (microprocessor without interlocked pipeline stages) cores, RISC-V cores, or CISC (complex instruction set computing) (i.e., x86) cores. Hardware accelerator may operate according to firmware instructions that may be occasionally updated.

In the illustrated embodiment, the programmable capabilities of hardware accelerator 250 implement functions used to support storage drives 235a, such as SSDs. In such storage drive topologies, hardware accelerator 250 may implement processing of PCIe NVMe communications with storage drives 235a, thus supporting high-bandwidth connections with the storage drives. Hardware accelerator 250 may also include one or more memory devices used to store program instructions executed by the processing cores and/or used to support the operation of storage drives 235a such as in implementing cache memories and buffers utilized in support of high-speed operation of these storage drives, and in some cases may be used to provide high-availability and high-throughput implementations of the read, write and other I/O operations that are supported by these storage drives 235a. In other embodiments, hardware accelerator 250 may implement operations in support of other types of devices and may similarly support high-bandwidth PCIe connections with these devices. For instance, in various embodiments, hardware accelerator 250 may support high-bandwidth connections, such as PCIe connections, with networking devices in implementing functions of a network switch, compression and codec functions, virtualization operations or cryptographic functions.

As illustrated in FIG. 2, PCIe switches 265a-b may also support PCIe couplings with one or more GPUs (Graphics Processing Units) 260. Embodiments may include one or more GPU cards, where each GPU card is coupled to one or more of the PCIe switches 265a-b, and where each GPU card may include one or more GPUs 260. In some embodiments, PCIe switches 265a-b may transfer instructions and data for generating video images by the GPUs 260 to and from CPUs 205. Accordingly, GPUs 260 may include one or more hardware-accelerated processing cores that are optimized for performing streaming calculation of vector data, matrix data and/or other graphics data, thus supporting the rendering of graphics for display on devices coupled either directly or indirectly to IHS 200. In some instances, GPUs may be utilized as programmable computing resources for offloading other functions from CPUs 205, in the same manner as hardware accelerator 250. GPUs 260 may operate according to firmware instructions that may be occasionally updated.

As illustrated in FIG. 2, PCIe switches 265a-b may support PCIe connections in addition to those utilized by GPUs 260 and hardware accelerator 250, where these connections may include PCIe links of one or more lanes. For instance, PCIe connectors 245 supported by a printed circuit board of IHS 200 may allow various other systems and devices to be coupled to IHS 200. Through couplings to PCIe connectors 245, a variety of data storage devices, graphics processors and network interface cards may be coupled to IHS 200, thus supporting a wide variety of topologies of devices that may be coupled to the IHS 200.

As described, IHS 200 includes a BMC 230 that supports remote management of IHS 200 and of various internal components of IHS 200. In certain embodiments, BMC 230 may operate from a different power plane from the processors 205 and other components of IHS 200, thus allowing the BMC 230 to operate, and management tasks to proceed, while the processing cores of IHS 200 are powered off. Various functions provided by the BIOS, including launching the operating system of the IHS 200, and/or functions of a TPM may be implemented or supplemented by the BMC 230. In some embodiments, the BMC 230 may perform various functions to verify the integrity of the IHS 200 and its hardware components prior to initialization of the operating system of IHS 200 (i.e., in a bare-metal state). In some embodiments, certain operations of the BMC 230, such as the operations described herein for updating firmware used by managed hardware components of IHS 200, may operate using validated instructions, and thus within the root of trust of IHS 200.

In some embodiments, BMC 230 may include a service processor 230a, or specialized microcontroller, which operates management software that supports remote monitoring and administration of IHS 200. The management operations supported by BMC 230 may be remotely initiated, updated, and monitored via a remote management interface 101, such as described with regard to FIG. 1. Remote access controller 230 may be installed on the motherboard of IHS 200 or may be coupled to IHS 200 via an expansion slot or other connector provided by the motherboard. In some instances, the management functions of the BMC 230 may utilize information collected by various managed sensors 225 located within the IHS 200. For instance, temperature data collected by sensors 225 may be utilized by the BMC 230 in support of closed-loop airflow cooling of the IHS 200. As indicated, BMC 230 may include a secured memory 230e for exclusive use by the BMC in support of management operations.

In some embodiments, BMC 230 may implement monitoring and management operations using MCTP (Management Component Transport Protocol) messages that may be communicated to managed devices 205, 235a-b, 240, 250, 255, 260 via management connections supported by a sideband bus 253. In some embodiments, the BMC 230 may additionally or alternatively use MCTP messaging to transmit Vendor Defined Messages (VDMs) via the in-line PCIe switch fabric supported by PCIe switches 265a-b. In some instances, the sideband management connections supported by BMC 230 may include PLDM (Platform Level Data Model) management communications with the managed devices 205, 235a-b, 240, 250, 255, 260 of IHS 200.

As illustrated, BMC 230 may include a network adapter 230c that provides the BMC with network access that is separate from the network controller 240 utilized by other hardware components of the IHS 200. Through secure connections supported by network adapter 230c, BMC 230 communicates management information with remote management interface 101. In support of remote monitoring functions, network adapter 230c may support connections between BMC 230 and external management tools using wired and/or wireless network connections that operate using a variety of network technologies. As a non-limiting example of a BMC, the integrated Dell Remote Access Controller (iDRAC) from Dell® is embedded within Dell servers and provides functionality that helps information technology (IT) administrators deploy, update, monitor, and maintain servers remotely.

Remote access controller 230 supports monitoring and administration of the managed devices of an HIS 200 via a sideband bus interface 253. For instance, messages utilized in device and/or system management may be transmitted using I2C sideband bus 253 connections that may be individually established with each of the respective managed devices 205, 235a-b, 240, 250, 255, 260 of the IHS 200 through the operation of an I2C multiplexer 230d of the BMC. As illustrated in FIG. 2, the managed devices 205, 235a-b, 240, 250, 255, 260 of IHS 200 are coupled to the CPUs 205, either directly or directly, via in-line buses that are separate from the I2C sideband bus 253 connections used by the BMC 230 for device management.

In certain embodiments, the service processor 230a of BMC 230 may rely on an I2C co-processor 230b to implement sideband I2C communications between the BMC 230 and the managed hardware components 205, 235a-b, 240, 250, 255, 260 of the IHS 200. The I2C co-processor 230b may be a specialized co-processor or micro-controller that is configured to implement an I2C bus interface used to support communications with managed hardware components 205, 235a-b, 240, 250, 255, 260 of HIS 200. In some embodiments, the I2C co-processor 230b may be an integrated circuit on the same die as the service processor 230a, such as a peripheral system-on-chip feature that may be provided by the service processor 230a. The sideband I2C bus 253 is illustrated as single line in FIG. 2. However, sideband bus 253 may be comprised of multiple signaling pathways, where each may be comprised of a clock line and data line that couple the BMC 230 to I2C endpoints 205, 235a-b, 240, 250, 255, 260.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

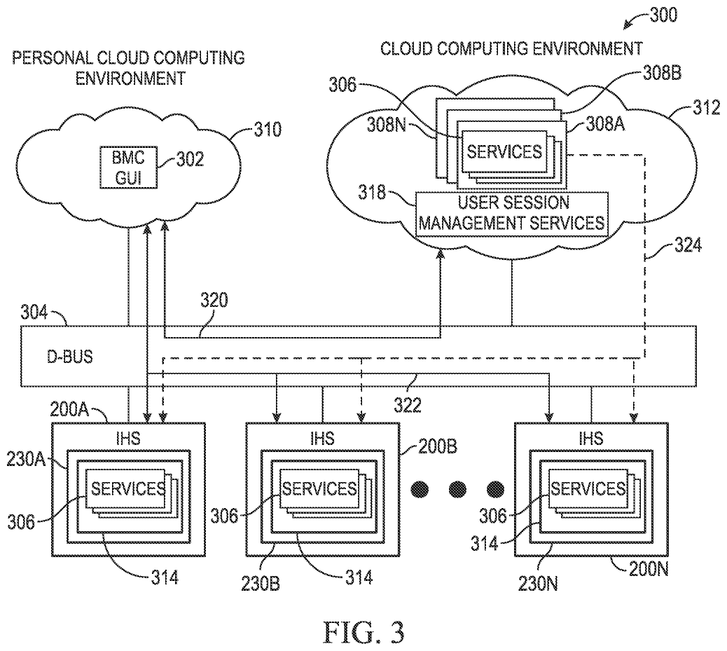

FIG. 3 illustrates several components of a cloud-based service distribution system 300 that may be used to distribute Baseboard Management Controller (BMC) services over a cloud architecture according to one embodiment of the present disclosure. The cloud-based service distribution system 300 includes a network of multiple IHSs 200a-n (collectively 200) that are each managed by a BMC GUI 302 configured in a personal cloud computing environment 310. According to embodiments of the present disclosure, the cloud-based service distribution system 300 includes a cloud-based BMC firmware 308a-n (collectively 308) running in a cloud computing environment 312 that executes one or more services 306 that have been offloaded from the BMCs 230 of each IHS 200. That is, certain services 306 that have conventionally been provided by each BMC 230 has been migrated to the cloud computing environment 312 to reduce the level of processing load incurred by each BMC 230.

Each BMC 230 executes a local BMC firmware 314, which is essentially a trimmed down version of a conventional BMC's firmware. Each local BMC firmware 314 configured in the BMC 230 may have a corresponding cloud-based BMC firmware 308 running in the cloud computing environment 312. For example, local BMC firmware 314a configured in BMC 230a may operate with cloud-based BMC firmware 308a to manage the operation of IHS 200a, local BMC firmware 314b configured in IHS 200b may operate with cloud-based BMC firmware 308b to manage the operation of IHS 200b, and local BMC firmware 314n configured in IHS 200n may operate with cloud-based BMC firmware 308n to manage the operation of IHS 200n.

Generally speaking, each cloud-based BMC firmware 308 provides a cloud space container to operate certain BMC features that may be resource (e.g., CPU, storage, etc.) intensive and may not require high levels of I/O operations. For example, a Machine Learning (ML) process that may be resource intensive, while not requiring an undue amount of I/O usage would be a prime candidate for execution by the cloud-based BMC firmware 308. Critical features that involve BMC management, such as thermal monitoring and control, power management, and security features (e.g., Oauth) would be executed by the local BMC firmware 314, while interfaces, telemetry processing and management, and certain configuration applications can be executed by the cloud-based BMC firmware 308. In one embodiment, certain applications or services running on the BMC 230 can be split up into two separate portions in which one portion is executed on the local BMC firmware 314, while the second portion is executed by the cloud-based BMC firmware 308.

One particular advantage that may be afforded by such an arrangement is that updates administered for those services 306 running on the cloud-based BMC firmware 308 would not require excessive downtime for the BMC 230. For example, performing a firmware update on a service 306 of the BMC 230 often requires it to be taken down while the firmware update is performed, and in many cases, a re-boot may be required to activate the new firmware, all of which requires a non-trivial amount of time to accomplish. Thus, by executing certain services 306 of the BMC 230 on the cloud-based BMC firmware 308, any updates to those services 306 may not require the BMC 230 to incur any downtime during update of the firmware in the cloud-based BMC firmware 308.

In one embodiment, the particular firmware, cloud-based BMC firmware 308 or local BMC firmware 314, that certain services 306 are executed in may be user configurable. That is, the BMC GUI 302 may communicate with the local BMC firmware 314 to migrate 322 certain services 306 from the local BMC firmware 314 to the cloud-based BMC firmware 308, and migrate 324 certain other services 306 from the cloud-based BMC firmware 308 to the local BMC firmware 314 as will be described in detail herein below.

The personal cloud computing environment 310 may be a private environment that a user (e.g., administrator of the IHSs 200) uses to securely manage the operation of the IHSs 200. For example, the BMC GUI 302 may be managed by an owner of the IHSs 200, such as an administrator of a group of IHSs 200 configured in a data center. For the purposes of this disclosure, the term “BMC GUI” may refer broadly to systems that are configured to couple to a management controller, such as a BMC 230, and issue management instructions for an information handling system (e.g., computing device) that is being managed by the management controller. One example of such a system management console is the DELL OpenManage Enterprise (OME) systems management console. In various embodiments, management consoles may be implemented via specialized hardware and/or via software running on a standard information handling system. In one embodiment, a system management console may be deployed on a secure virtual machine (VM), such as a VMWARE Workstation appliance.

The cloud computing environment 312 may be administered by any entity that provides resources (e.g., compute, storage, networking) for executing certain services 306 or a portion of a service 306 for the user of the IHS 200. In one embodiment, the cloud computing environment 312 may be administered by a vendor of the IHS 200 that develops the hardware and/or firmware for the BMC 230, which in turn manages the operation of its respective IHS 200.

The BMC GUI 302 and cloud-based BMC firmware 308 communicate with the local BMC firmware 314 through a backbone communication network 320, which in one example, may be the Internet. In one embodiment, the cloud computing environment 312 includes a user session management service 318 that may be used by the BMC GUI 302 to communicate with the services 306 running in the cloud-based BMC firmware 308 via a first login session 320. One particular advantage that may be provided by embodiments of the present disclosure is that a single sign on procedure performed by the user via the BMC GUI 302 provides access to the services 306 of all of the cloud-based BMC firmware 308 managed by the user.

The BMC GUI 302 may also communicate individually with each BMC 230 using a second login session 322. The second login session 322 may be used, for example, to communicate with services 306 that are security intensive or are critical to the operation of its respective IHS 200. Additionally, the services 306 of the cloud-based BMC firmware 308 may communicate with the services 306 of the local BMC firmware 314 using a communication link 324. In one embodiment, the first login session 320, second login session 322, and communication link 324 may be a secure communication channel, such as a Secure Shell (SSH) tunnel.

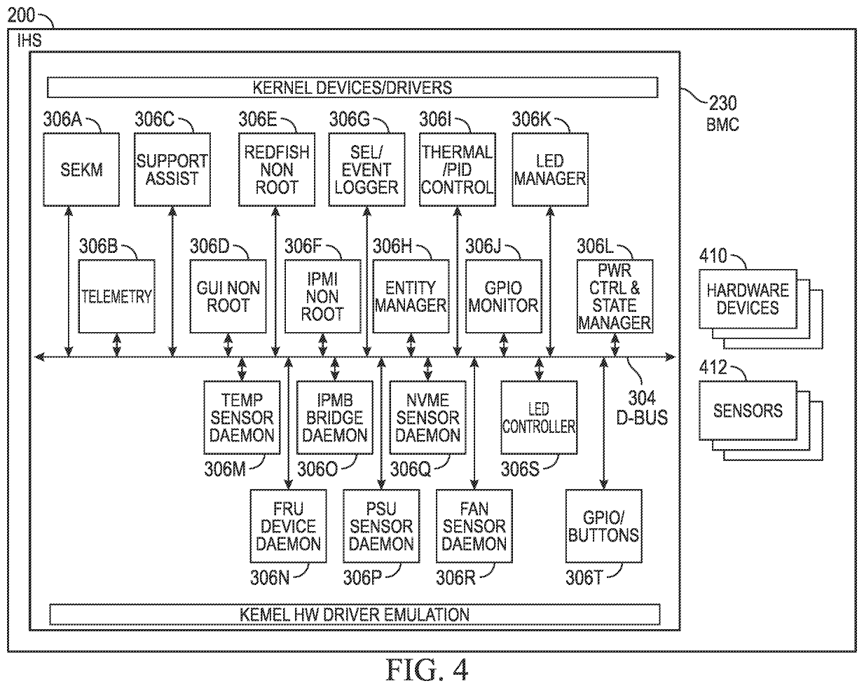

FIG. 4 illustrates several elements of an IHS 200 configured with a BMC 230 showing several example services 306 that may be executed by either the cloud-based BMC firmware 308 configured in the cloud computing environment 312, or the local BMC firmware 314 configured in each BMC 230 according to one embodiment of the present disclosure. The BMC 230 is configured with a D-Bus layer 304 and multiple D-Bus services 306a-t (collectively 306) that communicate with one another through the D-Bus layer 304. The IHS 200 also includes multiple hardware devices 410 and sensors 412 that may be managed by certain services 306. Each of the hardware devices 410 and sensors 412 may be any type, such as those described above with reference to FIGS. 1A-2.

The services 306 using the D-Bus 304 may be any suitable type, and may be generally delineated as hardware-based services or non-hardware-based services. A hardware-based service may be one that directly interacts with the hardware devices 410 or sensors 412 to, among other things, obtain telemetry metrics (e.g., measurements) from and/or control the operation of the hardware devices 410 or sensors 412, while a non-hardware-based service may be one that essentially has no direct interaction with the hardware devices 410 or sensors 412. Examples of non-hardware-based services may include a Secure Enterprise Key Manager (SEKM) module 306a, a support assist module 306c, a non-root GUI module 306d, a non-root redfish module 306e, an Intelligent Platform Management Interface (IPMI) module 306f, a SEL/Event logger module 306g, an entity manager 306h. Examples of hardware-based services may include a thermal/PID control module 306i, a GPIO monitor 306j, a LED manager 306k, a power control and state manager 306l, a telemetry module 306b, a temperature sensor daemon 306m, a Field Replaceable Unit (FRU) device daemon 306n, an IPMB bridge daemon 306o, a Power Supply Unit (PSU) sensor daemon 306p, an NVMe sensor daemon 306q, a fan sensor daemon 306r, an LED controller module 306s, and a GPIO/Buttons module 306t as shown in FIG. 3. It should be appreciated that other embodiments may have additional, fewer, or different services 306 than what is shown and described herein.

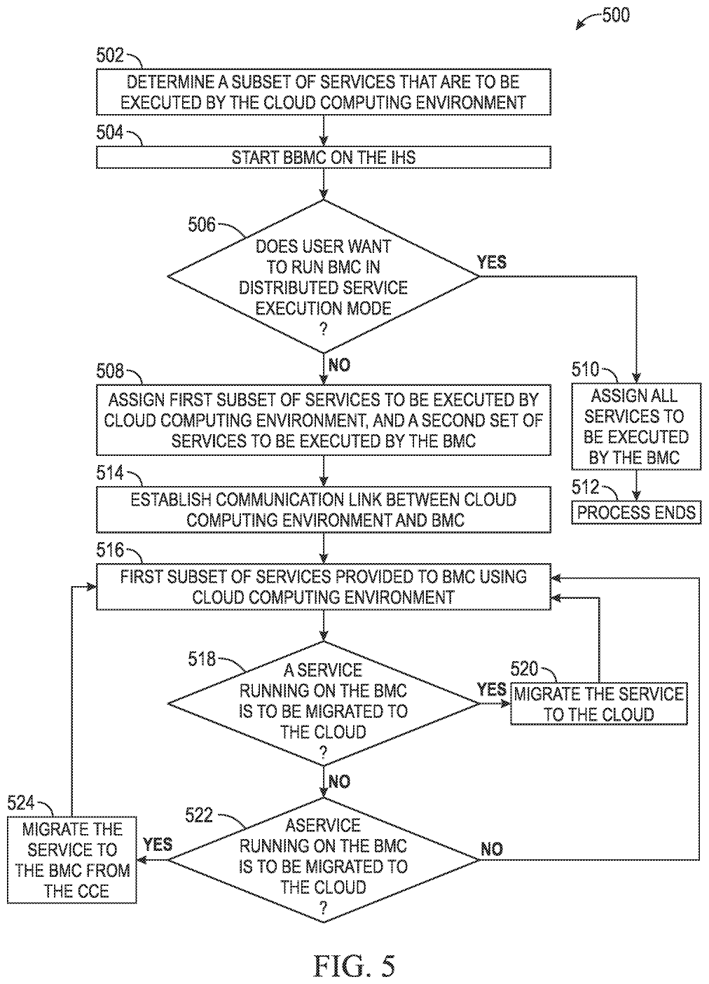

FIG. 5 illustrates an example cloud-based service distribution method 500 showing how multiple services 306 may be distributed between a BMC 230 and a cloud computing environment 312 according to one embodiment of the present disclosure. Additionally or alternatively, the cloud-based service distribution method 500 may be performed in whole or in part, by the cloud-based service distribution system 300 as shown and described above with reference to FIG. 3.

The cloud-based service distribution method 500 is described herein as being implemented on a BMC 230 that is configured with a D-Bus architecture. Nevertheless, it is contemplated that the cloud-based service distribution method 500 may be implemented on any BMC 230 that is configured with non-D-Bus-based services or utilities that may be offloaded to the cloud computing environment 312. The cloud-based service distribution method 500 may be particularly beneficial when used with BMCs 230 with a D-Bus architecture because, among other things, D-Bus enhances the modularity of how services 306 may be provided on the BMC 230. That is, D-Bus provides techniques to allow its services 306 to run relatively independent of one another, while providing means for those independent services 306 to effectively communicate with one another. Thus, BMCs 230 configured with D-Bus may be particularly conducive to having the cloud-based BMC firmware 308 offload certain services 306 for reducing its processing load when needed.

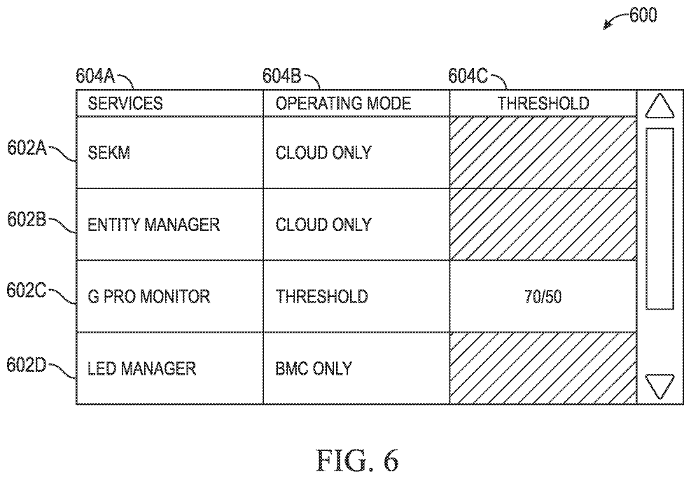

Initially at step 502, the cloud-based service distribution method 500 determines a subset of services 306 that are to be executed by the cloud computing environment 312. In one embodiment, the subset of services 306 may be user configurable. For example, a user (e.g., administrator) may have a certain service executed on the BMC of a first IHS due to the relatively sensitive security posture of the data handled by the first IHS, while having that service executed on the cloud computing environment associated with a second IHS because the data handled by the second IHS is not as security intensive. In another embodiment, the BMC GUI 302 may generate, such as whenever the BMC 230 is initially started or whenever the user desires to configure the BMC 230, a user service distribution selection window 600 such as shown in FIG. 6 to receive user input for determining whether each service 306 should be executed on either the cloud computing environment 312 or locally on the BMC 230.

Referring to FIG. 6, the user service distribution selection window 600 is provided in the form of a table having multiple rows 602 for some, most, or all services 306 provided on the BMC 230. For example, the user service distribution selection window 600 as shown includes a first row 602a for the SEKM service 306a, a second row 602b for the entity manager service 306h, a third row 602c for the GPIO manager 306j, and a fourth row for the LED manager 306k. The user service distribution selection window 600 also includes multiple columns in which a first column 604a represents the name of the service 306, a second column 604b represents a settable operating mode of the service 306, and a third column 604c represents a threshold value that may be used by the cloud-based service distribution system 300 to determine when to migrate a service 306 between operation on either the cloud computing environment 312 or BMC 230.

The fields in the operating mode column 604 are selectable by a user. For example, when a user selects a field in the operating mode column 604 a pop-up window may be displayed that allows the user to select either “Cloud Only,” “BMC Only,” or “Threshold.” If the “Cloud Only” field is selected, then the service 306 associated with that field will be assigned to be executed by the cloud computing environment 312. If the “BMC Only” field is selected, then the service 306 associated with that field will be assigned to be executed by the BMC 230. Additionally, if the “Threshold” field is selected, then the service 306 associated with that field will be migrated between the cloud computing environment 312 and BMC 230 whenever a processing load exceeds a specified threshold, which is a user selectable parameter. As shown for example, the GPIO monitor 306j has been selected to be migrated to the cloud computing environment 312 whenever a processing load of the BMC 230 exceeds a processing load of over 70 percent (%), such as over an averaged specified period of time (e.g., 15 minutes). In one embodiment, the threshold may be configured with hysteresis. That is, the “Threshold” field may be included with a second value, which in the present case is 50% indicating that the GPIO monitor 306j will be migrated back to the BMC 230 whenever the processing load of the BMC 230 goes below a processing load of over 50 percent (%) over the averaged specified period of time.

Referring again to FIG. 5, the BMC is started on the IHS 200 at step 504. Once the BMC 230 has started, the cloud-based service distribution method 500 may optionally request user input for deciding whether to run the BMC 230 in the distributed service execution mode or not at step 506. If the user selects to not run the BMC 230 in the distributed service execution mode, all services 306 will be executed on the BMC 230. If so, processing continues at step 508; otherwise, processing continues at step 510 in which all services 306 are assigned to be executed by the BMC 230, and the process ends at step 512.

At step 508, the cloud-based service distribution method 500 assigns a first subset of services 306 to be executed by the cloud computing environment 312, and a second set of services (e.g., the rest of the services) to be executed by the BMC 230. For example, the first set of services 306 may be assigned as described above with reference to FIG. 6. The cloud-based service distribution method 500 then establishes a communication link 324 between the cloud computing environment 312 and BMC 230 at step 514. In one embodiment, the communication link 324 is a secure communication link, such as an SSH tunnel. Thereafter at step 516 the first subset of services 306 are provided to the BMC 230 via the cloud computing environment 312.

At step 518, the cloud-based service distribution method 500 determines whether a service 306 running on the BMC 230 is to be migrated to the cloud computing environment 312. For example, a service 306 may have been assigned to be migrated based on a processing load of the BMC 230 exceeding a specified threshold such as described above with reference to FIG. 6. In some embodiments, the method 500 may determine that a service 306 should run on the BMC 230 or cloud computing environment 312 according to a security sensitivity level required by the service 306, and/or according to how critical the service 306 is to the operation of the IHS 200. If not, processing continues at step 522; otherwise processing continues at step 520, in which the cloud-based service distribution method 500 migrates the service 306 to the cloud computing environment 312. For example, the cloud-based service distribution method 500 may temporarily halt operation of the service 306, copy operating data from the BMC 230 to the cloud computing environment 312, start operation of the service 306 on the cloud computing environment 312, and cancel operation of the service 306 on the BMC 230.

At step 522, the cloud-based service distribution method 500 determines whether a service 306 running on the cloud computing environment 312 is to be migrated to the BMC 230. For example, a service 306 may have been assigned to be migrated to the BMC 230 based on a processing load of the BMC 230 going below the specified threshold such as described herein above. If not, processing continues at step 516 in which the cloud-based service distribution method 500 continues to monitor for events that trigger a migration request between the BMC 230 and cloud computing environment 312; otherwise processing continues at step 524, in which the cloud-based service distribution method 500 migrates the service 306 to the BMC 230 from the cloud computing environment 312.

Steps 516-524 may be continually performed throughout operation of the BMC 230 for monitoring conditions of the BMC 230 and migrating services 306 between the BMC 230 and cloud computing environment 312 for reducing process loading on the BMC 230. Nevertheless, when use of the cloud-based service distribution method 500 is no longer needed or desired, the method 500 ends.

Although FIG. 5 describes an example method 500 that may be performed to provide a distributed service for a BMC 230, the features of the disclosed processes may be embodied in other specific forms without deviating from the spirit and scope of the present disclosure. For example, certain steps of the disclosed method 500 may be performed sequentially, or alternatively, they may be performed concurrently. As another example, the method 500 may perform additional, fewer, or different operations than those operations as described in the present example. As yet another example, the steps of the processes described herein may be performed by an executable process other than the cloud-based service distribution system 300 as described above.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a Baseboard Management Controller (BMC) that is configured to execute a plurality of services for managing the operation of the IHS;
at least one processor; and
at least one memory coupled to the at least one processor, the at least one memory having program instructions stored thereon that, upon execution by the at least one processor, cause the IHS to:
execute a first subset of the services on the BMC; and
execute a second subset of the services on a cloud computing environment in communication with the BMC.

2. The IHS of claim 1, wherein the instructions, upon execution, cause the services executed on the cloud service to communicate with the BMC using a Secure Shell (SHH) tunnel.

3. The IHS of claim 1, wherein the services comprise a plurality of Desktop Bus (D-Bus) objects that communicate among one another using a D-Bus.

4. The IHS of claim 3, wherein the instructions, upon execution, cause the IHS to update a service on the cloud computing environment while the BMC remains operational.

5. The IHS of claim 1, wherein the instructions, upon execution, cause the IHS to determine, for each service, whether to execute the service on the cloud computing environment or the BMC according to a processing load level incurred by the service.

6. The IHS of claim 1, wherein the instructions, upon execution, cause the IHS to determine, for each service, whether to execute the service on the cloud computing environment or the BMC according to a security sensitivity level required by the service.

7. The IHS of claim 1, wherein the instructions, upon execution, cause the IHS to determine, for each service, whether to execute the service on the cloud computing environment or the BMC according to how critical the service is to the operation of the IHS.

8. The IHS of claim 1, wherein the instructions, upon execution, cause the IHS to receive user input for determining whether the services are executed in the cloud computing environment or the BMC.

9. A cloud-based service distribution method comprising:
providing a Baseboard Management Controller (BMC) that is configured to execute a plurality of services for managing the operation of an Information Handling System (IHS);
executing a first subset of the services on the BMC; and
executing a second subset of the services on a cloud computing environment in communication with the BMC.

10. The cloud-based service distribution method of claim 9, further comprising communicating, by the services executed on the cloud service, with the BMC using a Secure Shell (SSH) tunnel.

11. The cloud-based service distribution method of claim 10, further comprising updating a service on the cloud computing environment while the BMC remains operational.

12. The cloud-based service distribution method of claim 9, further comprising determining, for each service, whether to execute the service on the cloud computing environment or the BMC according to a processing load level incurred by the service.

13. The cloud-based service distribution method of claim 9, further comprising determining, for each service, whether to execute the service on the cloud computing environment or the BMC according to a security sensitivity level required by the service.

14. The cloud-based service distribution method of claim 9, further comprising determining, for each service, whether to execute the service on the cloud computing environment or the BMC according to how critical the service is to the operation of the IHS.

15. The cloud-based service distribution method of claim 9, further comprising receiving user input for determining whether the services are executed in the cloud computing environment or the BMC.

16. A memory storage device having program instructions stored thereon that, upon execution by one or more processors of a client Information Handling System (IHS), cause the client IHS to:
execute a first subset of the services on a Baseboard Management Controller (BMC) that is configured to execute a plurality of services for managing the operation of the IHS; and
execute a second subset of the services on a cloud computing environment in communication with the BMC.

17. The memory storage device of claim 16, wherein the instructions, upon execution, cause the services executed on the cloud service to communicate with the BMC using a Secure Shell (SHH) tunnel.

18. The memory storage device of claim 16, wherein the services comprise a plurality of Desktop Bus (D-Bus) objects that communicate among one another using a D-Bus.

19. The memory storage device of claim 18, wherein the instructions, upon execution, cause the IHS to update a service on the cloud computing environment while the BMC remains operational.

20. The memory storage device of claim 16, wherein the instructions, upon execution, cause the IHS to receive user input for determining whether the services are executed in the cloud computing environment or the BMC.
